(19) United States
(12) Patent Application Publication
(10) Pub. No.: US 2002/0063680 A1
(43) Pub. Date: May 30, 2002

(54) Encoder module for use in input device of graphic user interface

(75) Inventors: Chin-Kuan Lou, Taipei (TW); Yu-Chih Cheng, Taipei (TW); Bin-Hui Huang, Taipei (TW)

Correspondence Address: MADSON & METCALF, GATEWAY TOWER WEST, SUITE 900, 15 WEST SOUTH TEMPLE, SALT LAKE CITY, UT, 84101

(73) Assignee: Primax Electronics Ltd.

(21) Appl. No.: 09/816,500

(22) Filed: Mar. 23, 2001

(30) Foreign Application Priority Data
Nov. 30, 2000 (TW) 89126807

(51) Int. Cl. G09G 5/00

(52) U.S. Cl. 345/156

(57) ABSTRACT

An encoder module for use in an input device of a graphic user interface (GUI) is disclosed. The encoder module includes a disk key disposed outside a housing of the input device, an upright shaft coupled to the disk key, an encoder consisting of a fixed contact electrode formed on a circuit board and a rotatable contact electrode sleeved around the shaft, and a switch consisting of a conductive electrode formed on the circuit board and a sheet conductor mounted on the circuit board and spaced from the conductive electrode. By exerting a rotating force on the disk key, the rotatable contact electrode rotates accordingly to exhibit different contact status with the fixed contact electrode so as to generate a signal indicative of a rotation quantity. By exerting a pressing force on the disk key, the sheet conductor is deformed to be in contact with the conductive electrode so as to generate a signal indicative of a conductive state to complete the input operation.

### FIELD OF THE INVENTION

The present invention relates to an encoder module, and more particular to an encoder module for use in an input device of a graphic user interface.

### BACKGROUND OF THE INVENTION

A mouse is a most common input control device for personal computers. In view of the more and more complicated graphic user interface (GUI), the input control devices for computers such as a mouse are developed to have various operational keys. Please refer to FIG. 1 which is a schematic diagram showing the third dimensional (Z-axis) input control module of a conventional mouse. As shown, a roller 11 consisting of a plastic inner roller 111 and a rubber outer roller 112 is coupled to an encoder 13 at one side thereof via a shaft 12. The shaft 12 at the other side of the roller 11 overlies a key switch 14. When a user manipulates the roller 11 to rotate, the contact status of the electrodes of the encoder 13 changes therewith so that the encoder 13 outputs a control signal indicative of the rotation quantity of the roller 11, thereby controlling the operation in the Z-axis, e.g. scrolling up/down of screen. Then the user presses the roller 11 to have the shaft 12 sustain against the key switch 14 to complete input.

The input control module as shown above, however, is complicated in structure, and occupies too much space of the mouse. In addition, the cost is relatively high due to a large amount of elements.

### SUMMARY OF THE INVENTION

Therefore, an object of the present invention is to provide an encoder module for use in an input device, especially in a graphic user interface, which has a simplified structure compared to the conventional one.

Another object of the present invention is to provide an encoder module for use in an input device, especially in a graphic user interface, which occupies less inner space of the input device than the conventional one does.

A further object of the present invention is to provide an encoder module for use in an input device, especially in a graphic user interface, which has a reduced cost compared to the conventional one.

According to a first aspect of the present invention, an encoder module for use in an input device includes a disk key exposed from a housing of the input device for being optionally exerted thereon a rotating force and a pressing force; a shaft coupled to the disk key, rotating with the disk key in response to the rotating force, and moved along an axial direction thereof in response to the pressing force; an encoder including a fixed contact electrode, and a rotatable contact electrode sleeved around the shaft and rotating with the shaft to change a contact status thereof with the rotatable contact electrode for generating a first signal indicative of a rotation quantity; and a switch including a conductive electrode, and a sheet conductor deformed by the shaft in response to the pressing force to be in contact with the conductive electrode for generating a second signal indicative of a conductive state.

Preferably, the sheet conductor is of a dome shape.

Preferably, the rotatable contact electrode is of a sheet shape.

Preferably, the disk key is disposed outside the housing of the input device, and the shaft penetrates through the housing of the input device to be directly connected to a center portion of the disk key.

Preferably, the fixed contact electrode and the conductive electrode are formed on a circuit board.

Preferably, the encoder module further includes a stepping controller which includes a base ring secured on the circuit board, penetrating therethrough the shaft, and arranged thereon a plurality of equally-spaced radial ribs; and a rotatable ring sleeved around the shaft, rotating with the shaft to have a relative motion to the base ring, and arranged thereon a bump for intermittently engaging with the ribs so as to allow the disk key to perform a stepping operation.

Preferably, the disk key is arranged thereon a plurality of bumps for facilitating the exertion of said rotating force.

Preferably, the encoder module further includes a cover for accommodating therein the encoder, the switch and the stepping controller, which is secured on the circuit board, and penetrating therethrough the shaft.

The encoder module according to the present invention is suitable to be used in an input device for a personal computer such as a mouse device or a track-ball device.

According to a second aspect of the present invention, an encoder module for use in an input device includes a disk key for being optionally exerted thereon a rotating force and a pressing force; a shaft having one end thereof coupled to the disk key, rotating with the disk key in response to the rotating force, and moved along an axial direction thereof in response to the pressing force; an encoder for generating a first signal indicative of a rotation quantity in response to the rotating force; and a switch coupled to the other end of the shaft for generating a second signal indicative of a conductive state in response to the pressing force.

Preferably, the shaft has a top surface thereof sustaining against a center portion of the disk key for receiving the pressing force to move along the axial direction, and a bottom surface thereof sustaining against the switch for pressing the switch in response to the axial directional movement thereof.

Preferably, the encoder and the switch are secured on a circuit board, and accommodated in a cover which is secured on the circuit board.

In an embodiment, the encoder includes a fixed contact electrode formed on the circuit board, and a rotatable contact electrode sleeved around and rotating with the shaft, the rotatable contact electrode having different contact status with the fixed contact electrode according to different rotation quantity, thereby generating the first signal indicative of the rotation quantity.

In an embodiment, the switch includes a conductive electrode formed on the circuit board, and a flexible conductor of a dome shape sustaining against the bottom surface of the shaft, and deformed in response to the pressing force to be in a conductive state with the conductive electrode, thereby generating the second signal indicative of the conductive state.

According to a third aspect of the present invention, an encoder module for use in an input device includes a disk key exposed from a housing of the input device to be rotated by a rotating force exerted thereon; a shaft having one end thereof coupled to a center portion of the disk key, and rotating with the disk key in response to the rotating force; a circuit board substantially perpendicular to the shaft, and formed thereon a fixed contact electrode; and a rotatable contact electrode sleeved around and rotating with the shaft to exhibit different contact status with the fixed contact electrode, thereby generating a signal indicative of a rotation quantity.

Preferably, the encoder module further includes a sheet conductor of a dome shape sustaining against the other end of the shaft, and deformed to be in contact with a conductive electrode formed on the circuit board when a pressing force is exerted on the disk key to move the shaft along an axial direction, thereby generating a signal indicative of a conductive state.

According to a fourth aspect of the present invention, an encoder module for use in an input device includes a disk key rotatable by a rotating force exerted thereon; a shaft having one end thereof coupled to a center portion of the disk key, and rotating with the disk key in response to the rotating force; a circuit board substantially perpendicular to the shaft; and an encoder rotating with the shaft to exhibit different contact status with the circuit board, thereby generating a signal indicative of a rotation quantity.

Preferably, the encoder includes a contact electrode sleeved around the shaft to exhibit different contact status with another contact electrode formed on the circuit board in response to the rotating force.

Preferably, the encoder module further includes a switch which includes a conductive electrode secured on the circuit board; and a sheet conductor disposed under the shaft, and deformed by the shaft in response to a pressing force exerted on the disk key to be in contact with the conductive electrode for generating a signal indicative of a conductive state.

### BRIEF DESCRIPTION OF THE DRAWINGS

The present invention may best be understood through the following description with reference to the accompanying drawings, in which:

FIG. 1 is a schematic diagram showing the third dimensional input control module of a conventional mouse;

FIG. 2 is a schematic resolving diagram of a preferred embodiment of an encoder module of an input device according to the present invention;

FIG. 3A is a top plane view of the assembled encoder module of FIG. 2;

FIGS. 3B and 3C are cross-sectional views of the encoder module of FIG. 3A taken along the A-A′ and B-B′ lines, respectively; and

FIG. 4 is a schematic diagram showing an input device equipped with an encoder module according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

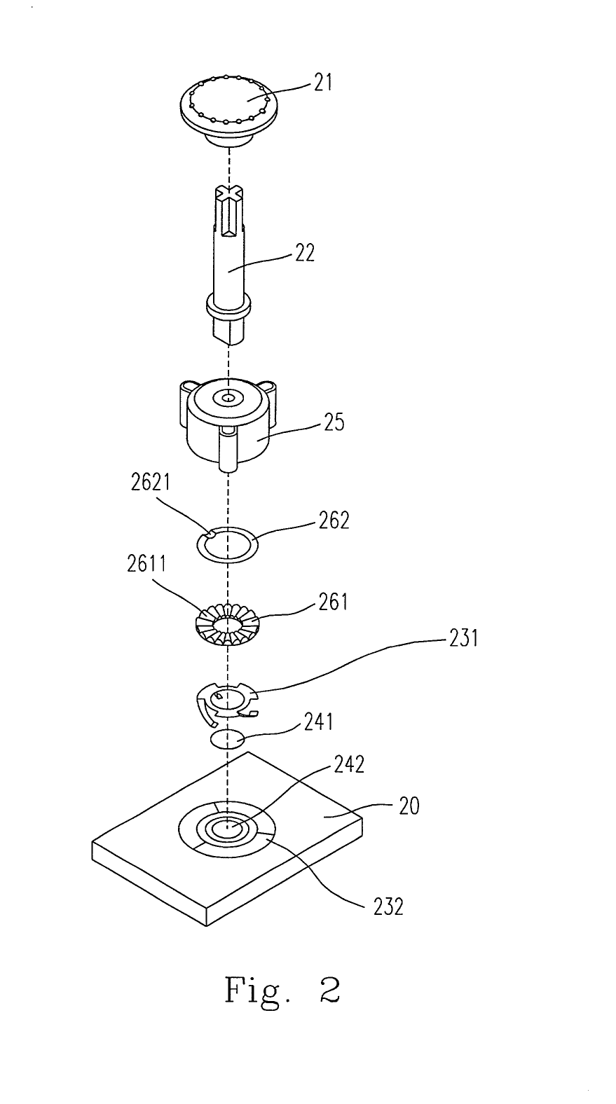

Please refer to FIG. 2 which schematically shows a preferred embodiment of an encoder module according to the present invention. The encoder module includes a disk 21, a shaft 22, a cover 25, a rotatable ring 262, a base ring 261, a rotatable contact electrode 231, a sheet conductor 241 of a metal dome, a conductive electrode 242, and a fixed contact electrode 232.

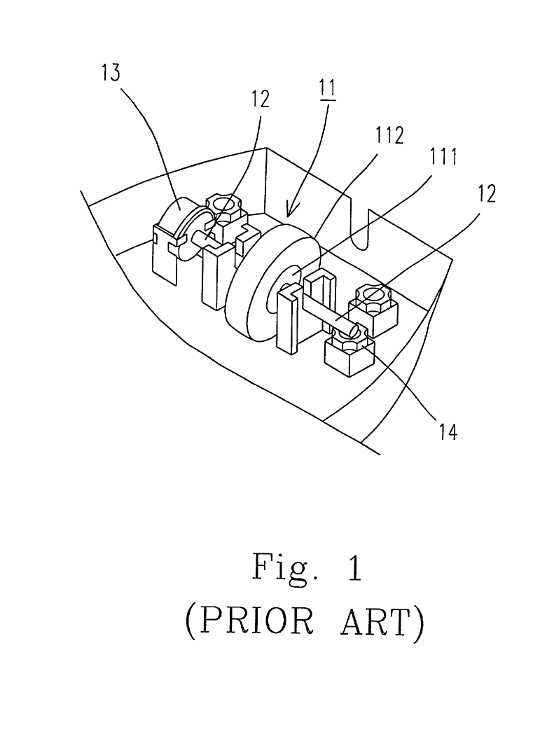

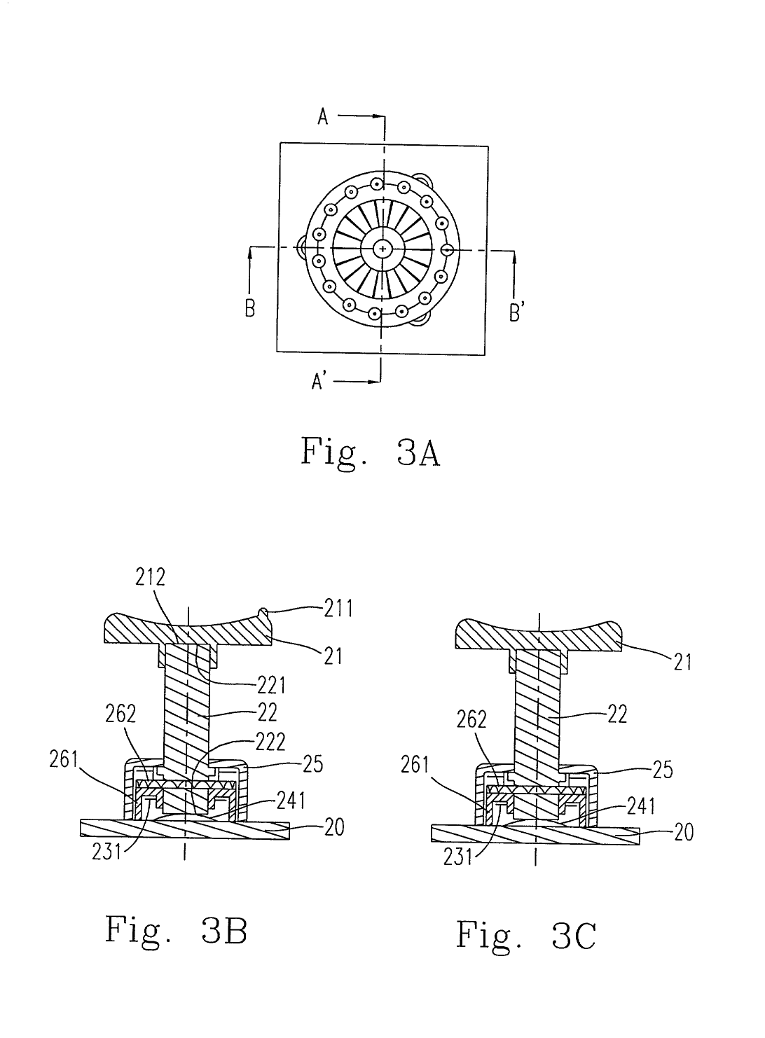

The assembled encoder module is shown on FIGS. 1-3 wherein FIG. 3A is a top plane view of the assembled encoder module of FIG. 2, and FIGS. 3B and 3C are cross-sectional views of the encoder module of FIG. 3A taken along the A-A′ and B-B′ lines, respectively. As shown, the shaft 22 having a top surface 221 thereof sustain against a center portion 212 of the disk 21, and a second end 222 thereof sustain against the metal dome 241. The rotatable contact electrode 231 and the rotatable ring 262 are sleeved around the shaft 22. The fixed contact electrode 232 and the conductive electrode 242 are formed on a circuit board 20 which is substantially perpendicular to the shaft 22. The base ring 261 and the cover 25 are secured on the circuit board 20, and having respective center openings for penetrating therethrough the shaft 22. The resulting assembly allows the rotatable ring 262, base ring 261, rotatable contact electrode 231, sheet conductor 241, conductive electrode 242, and fixed contact electrode 232 to be accommodated in the cover 25, allows the rotatable contact electrode 231 and the rotatable ring 262 to rotate with the shaft 22, and allows the metal dome 241 to be deformed by the press of the shaft 22.

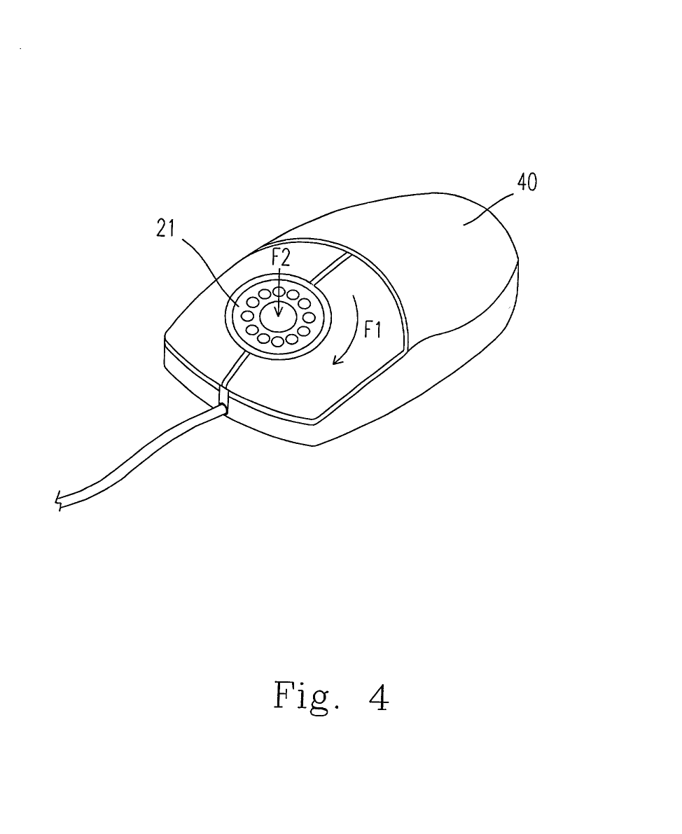

The disk key 21 is disposed outside the mouse housing 40, as shown in FIG. 4, by having the shaft 22 penetrating through the housing 40. When a user exerts a rotating force F 1 on the disk key 21, the shaft 22 rotates with the disk key 21, and drives the rotatable contact electrode 231 to rotate relative to the fixed contact electrode 232 on the circuit board 20. With the rotation of the rotatable contact electrode 231, the contact status between the rotatable contact electrode 231 and fixed contact electrode 232 changes so as to inform a rotation quantity of the disk key 21. Therefore, the rotatable contact electrode 231 and fixed contact electrode 232 function as an encoder for generating a signal indicative of the rotation quantity. For example, the rotation quantity may represent the scrolling lines on the screen.

The rotating force exerted on the disk key 21 also drives the rotatable ring 262 to rotate relative to the base ring 261 secured on the circuit board 20. The base ring 261 is arranged thereon a plurality of equally spaced radial ribs 2611, and the rotatable ring 262 is arranged thereon a bump 2621. With the rotation of the rotatable ring 262 relative to the base ring 261, the bump 2621 intermittently engages with the ribs 2611. Therefore, the base ring 261 and the rotatable ring 262 function as a stepping controller for allowing the user to feel a stepping operation of the disk key 21. Preferably, a plurality of bumps 211 are arranged on the disk key 21 for facilitating the exertion of the rotating force.

On the other hand, when a user exerts a pressing force F2 (FIG. 4) on the disk key 21, the shaft 22 will move downwards along the axial direction to deform the metal dome 241 to be in contact with the conductive electrode 242 on the circuit board 20. Therefore, the metal dome 241 and the conductive electrode 242 function as a switch for generating a signal indicative of a conductive state to complete the input operation.

According to the above embodiment, the encoder and the switch are integrated in a circuit board to simplify the structure and reduce the volume of the module. In addition, the encoder module can be mounted in the input device in an upright and compact manner so that a relatively small space is required. Further, the relatively small number of elements economize the manufacturing cost, either in material or in assembling efforts.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An encoder module for use in an input device, comprising:
a disk key exposed from a housing of said input device for being optionally exerted thereon a rotating force and a pressing force;
a shaft coupled to said disk key, rotating with said disk key in response to said rotating force, and moved along an axial direction thereof in response to said pressing force;
an encoder including a fixed contact electrode, and a rotatable contact electrode sleeved around said shaft and rotating with said shaft to change a contact status thereof with said rotatable contact electrode for generating a first signal indicative of a rotation quantity; and
a switch including a conductive electrode, and a sheet conductor deformed by said shaft in response to said pressing force to be in contact with said conductive electrode for generating a second signal indicative of a conductive state.

2. The encoder module according to claim 1 wherein said sheet conductor is of a dome shape.

3. The encoder module according to claim 1 wherein said rotatable contact electrode is of a sheet shape.

4. The encoder module according to claim 1 wherein said disk key is disposed outside said housing of said input device, and said shaft penetrating through said housing of said input device to be directly connected to a center portion of said disk key.

5. The encoder module according to claim 1 wherein said fixed contact electrode and said conductive electrode are formed on a circuit board.

6. The encoder module according to claim 5 further comprising a stepping controller which includes:
a base ring secured on said circuit board, penetrating therethrough said shaft, and arranged thereon a plurality of equally-spaced radial ribs; and
a rotatable ring sleeved around said shaft, rotating with said shaft to have a relative motion to said base ring, and arranged thereon a bump for intermittently engaging with said ribs so as to allow said disk key to perform a stepping operation.

7. The encoder module according to claim 6 wherein said disk key is arranged thereon a plurality of a plurality of bumps for facilitating the exertion of said rotating force.

8. The encoder module according to claim 5 further comprising a cover for accommodating therein said encoder, said switch and said stepping controller, which is secured on said circuit board, and penetrating therethrough said shaft.

9. The encoder module according to claim 1 wherein said input device is a mouse device.

10. The encoder module according to claim 1 wherein said input device is a track-ball device.

11. An encoder module for use in an input device, comprising:
a disk key for being optionally exerted thereon a rotating force and a pressing force;
a shaft having one end thereof coupled to said disk key, rotating with said disk key in response to said rotating force, and moved along an axial direction thereof in response to said pressing force;
an encoder for generating a first signal indicative of a rotation quantity in response to said rotating force; and
a switch coupled to the other end of said shaft for generating a second signal indicative of a conductive state in response to said pressing force.

12. The encoder module according to claim 11 wherein said shaft having a top surface thereof sustain against a center portion of said disk key for receiving said pressing force to move along said axial direction, and a bottom surface thereof sustain against said switch for pressing said switch in response to the axial directional movement thereof.

13. The encoder module according to claim 11 wherein said encoder and said switch are secured on a circuit board.

14. The encoder module according to claim 13 wherein said encoder and said switch are accommodated in a cover which is secured on said circuit board.

15. The encoder module according to claim 13 wherein said encoder includes a fixed contact electrode formed on said circuit board, and a rotatable contact electrode sleeved around and rotating with said shaft, said rotatable contact electrode having different contact status with said fixed contact electrode according to different rotation quantity, thereby generating said first signal indicative of said rotation quantity.

16. The encoder module according to claim 13 wherein said switch includes a conductive electrode formed on said circuit board, and a flexible conductor of a dome shape sustaining against said bottom surface of said shaft, and deformed in response to said pressing force to be in a conductive state with said conductive electrode, thereby generating said second signal indicative of said conductive state.

17. The encoder module according to claim 13 further comprising a stepping controller which includes:
a base ring secured on said circuit board, penetrating therethrough said shaft, and arranged thereon a plurality of equally-spaced radial ribs; and
a rotatable ring sleeved around said shaft, rotating with said shaft to have a relative motion to said base ring, and arranged thereon a bump for intermittently engaging with said ribs so as to allow said disk key to perform a stepping operation.

18. The encoder module according to claim 11 wherein said disk key is disposed outside a housing of said input device.

19. An encoder module for use in an input device, comprising:
a disk key exposed from a housing of said input device to be rotated by a rotating force exerted thereon;
a shaft having one end thereof coupled to a center portion of said disk key, and rotating with said disk key in response to said rotating force;
a circuit board substantially perpendicular to said shaft, and formed thereon a fixed contact electrode; and
a rotatable contact electrode sleeved around and rotating with said shaft to exhibit different contact status with said fixed contact electrode, thereby generating a signal indicative of a rotation quantity.

20. The encoder module according to claim 19 further comprising a sheet conductor of a dome shape sustaining against the other end of said shaft, and deformed to be in contact with a conductive electrode formed on said circuit board when a pressing force is exerted on said disk key to move said shaft along an axial direction, thereby generating a signal indicative of a conductive state.

21. The encoder module according to claim 19 further comprising a stepping controller which includes:
a base ring secured on said circuit board, penetrating therethrough said shaft, and arranged thereon a plurality of equally-spaced radial ribs; and
a rotatable ring sleeved around said shaft, rotating with said shaft to have a relative motion to said base ring, and arranged thereon a bump for intermittently engaging with said ribs so as to allow said disk key to perform a stepping operation.

22. An encoder module for use in an input device, comprising:
a disk key rotatable by a rotating force exerted thereon;
a shaft having one end thereof coupled to a center portion of said disk key, and rotating with said disk key in response to said rotating force;
a circuit board substantially perpendicular to said shaft; and
an encoder rotating with said shaft to exhibit different contact status with said circuit board, thereby generating a signal indicative of a rotation quantity.

23. The encoder module according to claim 22 wherein said encoder includes a contact electrode sleeved around said shaft to exhibit different contact status with another contact electrode formed on said circuit board in response to said rotating force.

24. The encoder module according to claim 22 further comprising a switch which includes:
a conductive electrode secured on said circuit board; and
a sheet conductor disposed under said shaft, and deformed by said shaft in response to a pressing force exerted on said disk key to be in contact with said conductive electrode for generating a signal indicative of a conductive state.

25. The encoder module according to claim 22 further comprising a stepping controller which includes:
a base ring secured on said circuit board, penetrating therethrough said shaft, and arranged thereon a plurality of equally-spaced radial ribs; and
a rotatable ring sleeved around said shaft, rotating with said shaft to have a relative motion to said base ring, and arranged thereon a bump for intermittently engaging with said ribs so as to allow said disk key to perform a stepping operation.
